(19) United States
(12) Patent Application Publication
(10) Pub. No.: US 2013/0029640 A1
(43) Pub. Date: Jan. 31, 2013

(54) FINGERPRINT SENSOR AND CHARGING SYSTEM

(71) Applicants: Kwok Fong WONG, Tsuen Wan (HK); Pui Yi Ching, Tsuen Wan (HK)

(72) Inventors: Kwok Fong WONG, Tsuen Wan (HK); Pui Yi Ching, Tsuen Wan (HK)

(21) Appl. No.: 13/558,936

(22) Filed: Jul. 26, 2012

(30) Foreign Application Priority Data
Jul. 27, 2011 (HK) 11107813.7

(51) Int. Cl. H04W 12/02

(52) U.S. Cl. 455/411

(57) ABSTRACT

A fingerprint sensor and charging system with an external device including a fingerprint sensor, an external battery and a charging device. A mobile communication terminal, the fingerprint sensor, the external battery and the charging device are connected to each other. The fingerprint sensor is used for capturing fingerprint data for registration and verification so as to perform open or close operation and access to the mobile communication terminal by the fingerprint verification. The mobile communication terminal is installed with an application software for accessing the fingerprint sensor to register and protect data in the mobile communication terminal by fingerprint verification. The fingerprint system is able to prevent the data in the mobile communication terminal from being accessed by an illegal holder in case the mobile communication terminal is stolen or lost by replacing a conventional password protection with a fingerprint verification, and thereby enhances security and convenience.

### TECHNICAL FIELD OF THE INVENTION

The invention relates to fingerprint sensor technology and, more particularly, relates to a fingerprint sensor and charging system

### BACKGROUND OF THE INVENTION

At present, in the market, most of the mobile communication terminals (mobile phone, PDA, etc.) do not include a fingerprint sensor. When the mobile communication terminals are stolen or lost, illegal holders of the mobile communication terminals are able to access freely to the data, such as phone telephone numbers in the phonebook, and cause loss to authorized holders of the mobile communication terminals.

### SUMMARY OF THE INVENTION

The object of the invention is to provide a fingerprint sensor and charging system which is able to prevent illegal holders from accessing freely to the data in mobile communication terminals.

The invention provides a fingerprint sensor and charging system, comprising an external device and a mobile communication terminal connected to the external device; wherein the external device includes a fingerprint sensor, an external battery and a charging device; the mobile communication terminal, the fingerprint sensor, the external battery and the charging device are connected to each other; the fingerprint sensor is used for capturing fingerprint data for registration and verification so as to perform turn on and off operation and access to the mobile communication terminal via the fingerprint verification; the charging device is used for charging the external battery; the external battery is used for providing power to the mobile communication terminal and the fingerprint sensor, and the mobile communication terminal is installed with an application software for accessing to the fingerprint sensor to register and protect data in the mobile communication terminal by fingerprint verification.

Preferably, the charging device is connected to alternating current.

Preferably, the mobile communication terminal includes a communication interface, via which the fingerprint sensor is connected to the mobile communication terminal.

Preferably, the fingerprint sensor is connected to the mobile communication terminal in a wireless connection manner.

Preferably, the mobile communication terminal includes a memory for storing the fingerprint data.

Preferably, the fingerprint sensor includes a memory for storing the fingerprint data.

Preferably, the charging device includes a charging port, via which the charging device is connected to external battery.

Preferably, the external battery includes an interface, via which the external battery is connected to the fingerprint sensor.

Preferably, the external battery includes an interface, via which the external battery is connected to the mobile communication terminal.

The invention is of advantage in that the holder of the mobile communication terminal should, in use of mobile communication terminal, be verified by the fingerprint sensor to perform turn on and off operation and access to the mobile communication terminal. Therefore, the invention is able to prevent an illegal holder of the mobile communication terminal from accessing freely to the data in the mobile communication terminal. In addition, the charging device is able to charge the external battery for providing power to the fingerprint sensor and the mobile communication terminal so as to increase the standby time of the mobile communication terminal.

### BRIEF DESCRIPTION OF THE DRAWINGS

The basic structure of the embodiment of the fingerprint sensor and charging system according to the invention will now be described exemplarily with reference to the drawings, in which:

FIG. 1 is a block diagram of the fingerprint sensor and charging system according to the invention; and

FIG. 2 shows the structure of the mobile communication terminal in FIG. 1.

### DETAILED DESCRIPTION OF THE DRAWINGS

To make the object, the technical solutions and the advantages of the invention more clear, the embodiments of the invention will now be described in detail with reference to the drawings. It should be understood that the schematic embodiments of the present invention and its explanation are for illustration only, but not for limit to the invention. The skilled in the art is able to make any variants and improvements to the present invention.

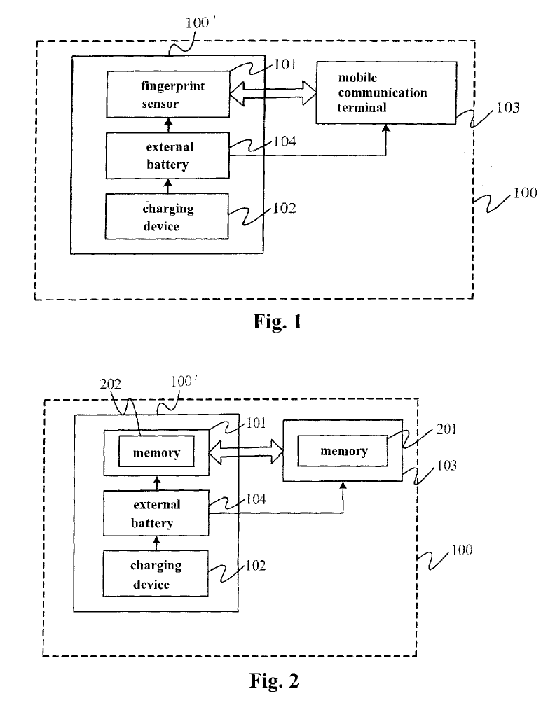

As shown in FIG. 1, the present invention provides a fingerprint sensor and charging system 100. The fingerprint sensor and charging system 100 comprises an external device 100′ and a mobile communication terminal 103. The external device 100′ includes a fingerprint sensor 101, an external battery 104 and a charging device 102.

The mobile communication terminal 103, the fingerprint sensor 101 and the charging device 102 are connected to the external battery 104 respectively. The mobile communication terminal 103 is connected to the fingerprint sensor 101.

The fingerprint sensor 101 is able to be connected to the mobile communication terminal 103 via a communication interface (not shown in the drawings) in the mobile communication terminal 103 and is also able to be connected to the mobile communication terminal 103 in a wireless connection manner. The skilled in the art can also think of other connection manners between the fingerprint sensor 101 and the mobile communication terminal 103. The present invention is not limited thereto.

The charging device 102 is able to be connected to the external battery 104 via a charging port (not shown in the drawings). The external battery 104 is able to be connected to the fingerprint sensor 101 via an interface (not shown in the drawings). The external battery 104 is able to be connected to the mobile communication terminal 103 via an interface (not shown in the drawings).

The fingerprint sensor 101 is used for capturing fingerprint data for registration and verification so as to perform turn on and off operation of the mobile communication terminal 103 and access to the mobile communication terminal 103 by the fingerprint verification, instead of by the traditional PIN code authentication.

The charging device 102 is used for charging the external battery 104. The charging device 102 is able to charge the external battery 104 by connecting the charging device 102 to alternative current, or by energy stored in the charging device 102 itself. The charged external battery 104 may supply power to the mobile communication terminal 103 and the fingerprint sensor 101.

The mobile communication terminal 103 is installed with an application software for accessing to the fingerprint sensor 101 to register and protect data in the mobile communication terminal 103 by fingerprint verification. The mobile communication terminal 103 can be of a mobile phone, PDA or other devices

Preferably, the fingerprint sensor 101 is able to be bundled together with the charging device 102 and the external battery 104 as a subsidiary external accessory of mobile communication terminal 103. Therefore, the fingerprint sensor 101, the charging device 102 and the external battery 104 in the present system 100 can be easily applied to the market to any mobile communication terminal without an internal fingerprint sensor therein. Because the mobile communication terminal 103 is installed with an application software, the mobile communication terminal 103 is able to protect the data in the mobile communication terminal by fingerprint verification.

When the fingerprint sensor 101 and the mobile communication terminal 103 is connected via the communication interface in the mobile communication terminal 103, the communication between the fingerprint sensor 101 and the mobile communication terminal 103 is based on a communication interface agreement. Therefore, the mobile communication terminal 103 is able to control the fingerprint sensor for different operations via this kind of communication.

As shown in FIG. 2, preferably, the mobile communication terminal 103 may include a memory 201 for storing the fingerprint data. The fingerprint sensor 101 may also include a memory 202 for storing the fingerprint data.

In the invention, the main function of the fingerprint sensor in the mobile communication terminal is to protect data and control the access of user to the mobile communication terminal by fingerprint verification. Before any data protection via fingerprint verification, the owner of the mobile communication terminal fingerprint should conduct a fingerprint registration process. In this process, personal biometric information of the owner is registered and stored in the system. The system uses the registered biometric information to protect data and control the access of the user to the mobile communication terminal. These functions are implemented in the mobile communication terminal via the application software.

The data in the mobile communication terminal include phone book, SMS, Internet information, game information and the setup and management information of the mobile communication terminal, and also include other data within the mobile communication terminal, and so on.

When the holder of the mobile communication terminal wants to access to the phone book, fingerprint verification is needed. Only the holder that passes the fingerprint verification can access to the mobile communication terminal in the phone book.

In traditional mobile communication terminals, the access of the anonymous users to the mobile communication terminal is protected by passwords. The present invention uses fingerprint verification, instead of password verification, to enhance security and convenience.

The invention is of advantage in that the holder of the mobile communication terminal should, in use of mobile communication terminal, be verified by the fingerprint sensor to perform turn on and off operation and access to the mobile communication terminal. Therefore, the invention is able to prevent an illegal holder of the mobile communication terminal to access freely to the data in the mobile communication terminal. In addition, the charging device is able to charge the external battery for providing power to the fingerprint sensor and the mobile communication terminal to increase the standby time of the mobile communication terminal.

The object, the technical solution and the advantages of the invention have been further explained with reference to the above embodiments. It should be understood that the above are only the examples of embodiments of the present invention and it is not used to limit the scope of protection of the invention. Any changes, equivalent replacement and improvement made within the spirit and principles of the present invention shall be included within the scope of protection of the present invention.

What is claimed is:

1. A fingerprint sensor and charging system, comprising an external device and a mobile communication terminal connected to the external device; wherein
the external device includes a fingerprint sensor, an external battery and a charging device;
the mobile communication terminal, the fingerprint sensor, the external battery and the charging device are connected to each other;
the fingerprint sensor is used for capturing fingerprint data for registration and verification so as to perform turn on and off operation and access to the mobile communication terminal via the fingerprint verification;
the charging device is used for charging the external battery;
the external battery is used for providing power to the mobile communication terminal and the fingerprint sensor, and
the mobile communication terminal is installed with an application software for accessing to the fingerprint sensor to register and protect data in the mobile communication terminal by fingerprint verification.

2. The fingerprint sensor and charging system according to claim 1, wherein the charging device is connected to alternating current.

3. The fingerprint sensor and charging system according to claim 1, wherein the mobile communication terminal includes a communication interface, via which the fingerprint sensor is connected to the mobile communication terminal.

4. The fingerprint sensor and charging system according to claim 1, wherein the fingerprint sensor is connected to the mobile communication terminal in a wireless connection manner.

5. The fingerprint sensor and charging system according to claim 1, wherein the mobile communication terminal includes a memory for storing the fingerprint data.

6. The fingerprint sensor and charging system according to claim 1, wherein the fingerprint sensor includes a memory for storing the fingerprint data.

7. The fingerprint sensor and charging system according to claim 5, wherein the fingerprint sensor includes a memory for storing the fingerprint data.

8. The fingerprint sensor and charging system according to claim 1, wherein the charging device includes a charging port, via which the charging device is connected to external battery.

9. The fingerprint sensor and charging system according to claim 1, wherein the external battery includes an interface, via which the external battery is connected to the fingerprint sensor.

10. The fingerprint sensor and charging system according to claim 1, wherein the external battery includes an interface, via which the external battery is connected to the mobile communication terminal.
